(19) United States
(12) Patent Application Publication
(10) Pub. No.: US 2025/0312738 A1
(43) Pub. Date: Oct. 9, 2025

(54) CATALYTIC ARTICLE COMPRISING AMMONIA OXIDATION CATALYST

(71) Applicant: BASF CORPORATION, Florham Park, NJ (US)

(72) Inventors: Yufen HAO, Shanghai (CN); Jiadi ZHANG, Shanghai (CN); Dongliang WU, Shanghai (CN); Mingming WEI, Shanghai (CN); Yu DAI, Shanghai (CN); Xiuhua WU, Shanghai (CN)

(21) Appl. No.: 18/881,631

(22) PCT Filed: Jul. 4, 2023
(86) PCT No.: PCT/CN2023/105719

§ 371 Date: Jan. 6, 2025

(30) Foreign Application Priority Data
Jul. 5, 2022 (WO) PCT/CN2022/103928

(51) Int. Cl. B01D 53/94

(52) U.S. Cl. CPC B01D 53/9436; B01D 2255/20738; B01D 2255/20761; B01D 2255/50; B01D 2255/9022; B01D 2255/9205

(57) ABSTRACT

A catalytic article for treating an exhaust stream comprising: a substrate, a coating layer, comprising a first catalyst containing a precious metal component and a second catalyst containing a molecular sieve component, in a first coating configuration; or a substrate, a first coating layer, which comprises a first catalyst containing a precious metal component, and a second coating layer, which covers at least part of the first coating layer and comprises a second catalyst containing a molecular sieve component, in a second coating configuration; wherein the coating layer in the first coating configuration or the second coating layer in the second coating configuration has inter-particle pores at a pore ratio of 5.7% or more respectively. The present invention also relates to a process for preparing the catalytic article by using a pore-forming agent in the slurry for depositing a coating layer, and to a system for treating an exhaust stream.

### TECHNICAL FIELD

The invention relates to selective ammonia oxidation (AMOₓ) catalysts, methods for their manufacture, and catalyst systems for treating an exhaust gas stream.

### BACKGROUND OF ART

Diesel engine exhaust is a heterogeneous mixture comprising particulate emissions such as soot and gaseous emissions including carbon monoxide (CO), unburned or partially burned hydrocarbons (HC), and nitrogen oxides (collectively referred to as NOx). Catalyst compositions, often disposed on one or more monolithic substrates, are placed in engine exhaust treatment systems to convert certain or all of these exhaust components to innocuous compounds. Control of NOx emission is always one of the most important topics for exhaust treatment, particularly for diesel engines, due to the environmentally negative impact of NOx on ecosystem, human beings, animals and plants.

Various treatment processes, for example catalytic reduction of nitrogen oxides, have been used to abate NOx in exhaust gases. One typical catalytic reduction process is selective catalytic reduction with ammonia (NH₃) or ammonia precursor as a reducing agent in the presence of atmospheric oxygen, which is also referred to as SCR process. The SCR process is considered superior since a high degree of NOx abatement can be obtained with a small amount of reducing agent. Typically, the nitrogen oxides and the reducing agent NH3 are reacted in accordance with following equations:

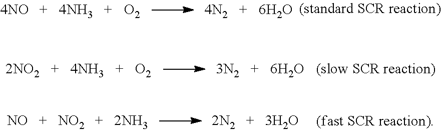

In the SCR process, a stoichiometric excess of the reducing agent ammonia or precursor thereof is usually dosed into the exhaust stream to abate NOx at a conversion as high as possible. The excess ammonia may exit the exhaust pipe of an automobile. Another potential scenario where ammonia may exit the exhaust pipe is desorption of a considerable amount of ammonia, which has been retained on Lewis and Brønsted acidic sites on the surface of a SCR catalyst during low temperature portions of a typical driving cycle, from the SCR catalyst when the operation temperature increases. A number of problems will arise if release of ammonia into air occurs, which is also referred to as ammonia slip. Ammonia slip is detrimental to human's health and to the environment. It was known that ammonia may cause noticeable eye and throat irritation above 100 ppm, noticeable skin irritation above 400 ppm, and the IDLH value of ammonia is 500 ppm in air. In addition, ammonia is caustic, especially in its aqueous form. Condensation of ammonia and water in cooler regions of the exhaust line downstream of exhaust catalysts will result in a corrosive mixture, damaging to the exhaust line. Ammonia should be eliminated before passing into the tailpipe.

An ammonia oxidation (AMOx) catalyst (also known as ammonia slip catalysts (ASC)) installed downstream of an SCR catalyst is generally used to convert the slipped ammonia into N₂. Such catalysts are known, which generally comprise a precious metal active species for oxidizing ammonia, and usually also comprise an SCR active species.

WO2010/062730A2 describes a catalyst system for treating an exhaust gas stream containing NOx, the system comprising at least one monolithic catalyst substrate; an undercoat washcoat layer coated on one end of the monolithic substrate, and containing a material composition A effective for catalyzing NH₃ oxidation; and an overcoat washcoat layer coated over a length of the monolithic substrate sufficient to overlay at least a portion of the undercoat washcoat layer, and containing a material composition B effective to catalyze selective catalytic reduction (SCR) of NOx, which may contains a zeolitic or non-zeolitic molecular sieve.

WO2017/037006A1 describes a catalyst for oxidizing ammonia comprising a washcoat including copper or iron on a small pore molecular sieve material having a maximum ring size of eight tetrahedral atoms physically mixed with platinum or platinum and rhodium on a refractory metal oxide support. A zoned catalyst for oxidizing ammonia is also described in the patent application, which comprises a first washcoat zone including copper or iron on a small pore molecular sieve material having a maximum ring size of eight tetrahedral atoms, the first washcoat zone being substantially free of platinum group metal; and a second washcoat zone including copper or iron on a small pore molecular sieve material having a maximum ring size of eight tetrahedral atoms physically mixed with platinum on a refractory metal oxide support including alumina, silica, zirconia, titania, and physical mixtures or chemical combinations thereof, including atomically doped combinations.

WO2020/210295A1 describes a catalyst comprising an AMOx catalyst and a SCR catalyst, wherein the SCR catalyst is located in a zone upstream of the AMOx catalyst, located in a layer above the AMOx catalyst, or homogeneously blended with the AMOx catalyst, or any combination thereof. The AMOx catalyst contains a platinum group metal on a support and the SCR catalyst comprises a zeolitic or non-zeolitic molecular sieve and optionally a prompter metal.

US2021/0299643A1 describes a catalytic article which comprises a substrate having an inlet and an outlet, a first coating comprising a blend of (1) platinum on a support and (2) a first SCR catalyst, and a second coating comprising a second SCR catalyst, wherein the support comprises at least one of a molecular sieve or a SiO₂-Al₂O₃ mixed oxide and wherein the first SCR catalyst comprises a Cu-and Mn-exchanged molecular sieve.

Excellent catalytic performance of an AMOx catalyst in terms of NH₃ conversion at a low temperature, particularly around 250° C., is important since the exhaust temperature will decrease to such a temperature when the exhaust arrives at the AMOx catalyst after passing through upstream exhaust treatment components, for example one or more of a diesel oxidation catalyst (DOC), a filter and a SCR catalyst.

It will be desirable if an AMOx catalyst has an improved catalytic performance for converting the slipped ammonia into N₂ at a low temperature.

### SUMMARY OF THE INVENTION

It is an object of the present invention to provide a catalytic article comprising a SCR catalyst and a precious metal based catalyst, which can perform better than conventional AMOx catalytic article for converting slipped ammonia at a low temperature, particularly around 250° C.

The object was achieved by a catalytic article which includes a porous coating layer comprising a molecular sieve component on a substrate.

Accordingly, in the first aspect, the present invention relates to a catalytic article for treating an exhaust stream, which comprises
a substrate,
a coating layer, comprising a first catalyst containing a precious metal component and a second catalyst containing a molecular sieve component, in a first coating configuration; or
a substrate,
a first coating layer, which comprises a first catalyst containing a precious metal component, and
a second coating layer, which covers at least part of the first coating layer and comprises a second catalyst containing a molecular sieve component, in a second coating configuration;
wherein the coating layer in the first coating configuration or the second coating layer in the second coating configuration has inter-particle pores at a pore ratio of 5.7% or more respectively.

In the second aspect, the present invention relates to a process for preparing a catalytic article for treating an exhaust stream, which comprises
applying a slurry comprising a first catalyst containing a precious metal component, a second catalyst containing a molecular sieve component and a pore-forming agent onto a substrate, optionally drying, and calcining to form a coating layer in a first coating configuration, or
applying a first slurry comprising a first catalyst containing a precious metal component onto a substrate, and drying and/or calcining to form a first coating layer, and then applying a second slurry comprising a second catalyst containing a molecular sieve component and a pore-forming agent, optionally drying, and calcining to form a second coating layer in a second coating configuration, wherein the pore-forming agent is in form of particles and used in an amount of at least 15% by weight, based on the loading of coating layer in the first coating configuration or the second coating layer in the second coating configuration respectively.

In the third aspect, the present invention relates to a system for treating an exhaust stream, which comprises a reductant source (e.g., NH₃ or a precursor thereof), the catalytic article as described herein, and optionally one or more of diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

In the fourth aspect, the present invention relates to a method for treatment of an exhaust stream containing nitrogen oxides, which comprises contacting the exhaust stream with the catalytic article as described herein or passing the exhaust stream through the system as described herein, in the presence of NH₃ as a reductant.

It has been surprisingly found by the inventors that the AMOx catalytic article having a porous coating containing a molecular sieve component according to the present invention can provide improved NH₃ conversion at a low temperature, particularly around 250° C., compared with AMOx catalytic articles which do not have the porous coating as described herein.

### DETAILED DESCRIPTION OF THE INVENTION

The present invention will be described in detail hereinafter. It is to be understood that the present invention may be embodied in many different ways and shall not be construed as limited to the embodiments set forth herein.

Herein, the singular forms “a”, “an” and “the” include plural referents unless the context clearly dictates otherwise. The terms “comprise”, “comprising”, etc. are used interchangeably with “contain”, “containing”, etc. and are to be interpreted in a non-limiting, open manner. That is, e.g., further components or elements may be present. The expressions “consists of” or “consists essentially of” or cognates may be embraced within “comprises” or cognates.

Herein, the term “inter-particle pores” refers to pores formed during the preparation of a coating layer, including voids resulted from stacking of starting material particles and the voids left by burning-off the pore-forming agent, which does not encompass intrinsic inner-particle pores in starting material particles.

Herein, any reference to “upstream” and “downstream” will be understood to be relative positions with respect to an exhaust stream flow direction, for example flow direction of an exhaust stream.

As used herein, the term “coating” designates a covering which is deposited on surfaces of walls of a substrate which define channels for exhaust stream passing through. A coating may consist of a single coating layer or consist of two or more coating layers. It is to be understood that a coating layer may be prepared by repeating a coating step twice or more to attain a targeted loading and thus will comprise more than one sub-layer having the same chemical composition and catalytic activity. Such a coating layer comprising more than one sub-layer having the same chemical composition and catalytic activity will be referred to one coating layer.

The term “pore ratio” as used herein within the context of a coating layer means the ratio of a total section area of pores to a total section area of the coating layer in a cross section surface perpendicular to the axial direction (i.e., exhaust stream flow passage direction) of the substrate, as measured by SEM.

As used herein, the term “solid content” is intended to refer to content of matters which are non- volatile under a calcination condition, expressed as a ratio of weights measured before and after a calcination process, for example at 500° C. for 1 hour.

According to the first aspect, the present invention provides a catalytic article for treating an exhaust stream, which comprises
a substrate,
a coating layer, comprising a first catalyst containing a precious metal component and a second catalyst containing a molecular sieve component,
in a first coating configuration; or
a substrate,
a first coating layer, which comprises a first catalyst containing a precious metal component, and
a second coating layer, which covers at least part of the first coating layer and comprises a second catalyst containing a molecular sieve component,
in the second coating configuration;
wherein the coating layer in the first coating configuration or the second coating layer in the second coating configuration has inter-particle pores at a pore ratio of 5.7% or more respectively.

In some particular embodiments, the catalytic article for treating an exhaust stream according to the present invention comprises or
a substrate,
a first coating layer, which comprises a first catalyst containing a precious metal component, and
a second coating layer, which covers at least part of the first coating layer and comprises a second catalyst containing a molecular sieve component,
wherein the second coating layer has inter-particle pores at a pore ratio of 5.7% or more.

### Substrate

The substrate useful in the catalytic article according to the present invention generally refers to a structure that is suitable for withstanding conditions encountered in exhaust streams, on which a catalytic material is carried, in the form of a coating, typically a washcoat. The substrate may have an inlet end and an outlet end which define an axial length thereof and a plurality of fine, parallel gas flow passages extending along the axial length.

The substrate is usually inert and conventionally made of, for example, ceramic or metal materials, which is also known as “inert substrate”. The substrate may alternatively be active, and may consist of, for example, extrudate containing catalytically active species.

The substrate may be a monolithic flow-through structure, which has a plurality of fine, parallel gas flow passages extending from an inlet end to an outlet end of the substrate such that passages are open to fluid flow therethrough. The passages, which are essentially straight paths from their fluid inlet to their fluid outlet, are defined by walls on which the catalytic material is applied as one or more coatings (e.g., washcoats) so that the gases flowing through the passages contact the catalytic material. The flow passages of the monolithic substrate are thin-walled channels, which can be of any suitable cross-sectional shape and size such as trapezoidal, rectangular, square, sinusoidal, hexagonal, oval, circular, etc. Such structures may contain 60 to 900 or more flow passages (or “cells”) per square inch of cross section. For example, the substrate may have 60 to 700 cells per square inch (“cpsi”). The wall thickness of flow-through substrates may vary, with a typical range from 2 mils to 0.1 inches.

The substrate may also be a monolithic wall-flow structure having a plurality of fine, parallel gas flow passages extending along from an inlet end to an outlet end of the substrate wherein alternate passages are blocked at opposite ends. The passages are defined by walls on which the catalytic material is applied as one or more coatings (e.g., washcoats) so that the gases flowing through the passages contact the catalytic material. The configuration requires the gases flow through the porous walls of the wall-flow substrate to reach the outlet end. The wall-flow substrates may have up to 700 cpsi, for example 100 to 400 cpsi. The flow passages of the monolithic substrate are thin-walled channels, which can be of any suitable cross-sectional shape and size such as trapezoidal, rectangular, square, sinusoidal, hexagonal, oval, circular, etc. The wall thickness of wall-flow substrates may vary, with a typical range from 2 mils to 0.1 inches.

The term “washcoat” has its usual meaning in the art and refers to a thin, adherent coating of a catalytic or other material applied to a substrate. A washcoat is generally formed by preparing a slurry containing the desired material and optionally processing aids such as binder with a certain solid content (e.g., 15 to 60% by weight) and then applying the slurry onto a substrate, dried and calcined to provide a washcoat layer. The washcoat, in form of one or more layers, is generally loaded on the substrate in an amount of 0.1 to 10 g/in^{3,} for example 0.3 to 7 g/in^{3,} or 0.5 to 4 g/in³.

### First Catalyst

The first catalyst may be a precious metal based oxidation catalyst commonly used to catalyze the conversion of NH₃ to form N_{2,} which generally comprises a precious metal component, preferably a platinum group metal component. The precious metal component may contain one or more selected from ruthenium, rhodium, iridium, palladium, platinum, silver and gold, on particles of a support. Preferably, the precious metal component contains one or more selected from ruthenium, rhodium, iridium, palladium and platinum, more preferably palladium and platinum, most preferably platinum, on particles of a support.

In some embodiments, the precious metal component is substantially free of any platinum group metals (PGMs) other than Pt, especially substantially free of any precious metal other than Pt.

Herein, the term “substantially free” within the context of the precious metal component is intended to mean no PGM or precious metal other than Pt has been intentionally added or used. It will be appreciated by those of skill in the art that a trace amount of the impurity PGM or precious metal from raw materials may impossibly be avoided. The trace amount generally refers to an amount of less than 1% by weight, including less than 0.75% by weight, less than 0.5% by weight, less than 0.25% by weight, or less than 0.1% by weight.

It will be understood that the precious metal may be present in any possible valence state, for example respective metals or metal oxides as the catalytically active form, or may be for example respective metal compounds, complexes or the like, which decompose or otherwise convert to the catalytically active form upon calcination or use of the catalyst.

Useful materials as the support for the precious metal in the first catalyst may be any materials suitable for receiving and carrying precious metals, for example molecular sieves, oxides of a metal selected from the group consisting of Ti, Si, W, Al, Ce, Zr, Mg, Ca, Ba, Y, La, Pr, Nb, Mo, Mn, Fe, Co, Ni, Cu, Zn, Ga, Sn, Sm, Eu, Hf, and Bi.

Particularly, the support for the precious metal may be selected from high surface area alumina (e.g., γ-alumina having a specific surface area of 50 to 300 m^{2/}g), silica, titania, ceria, zirconia, lanthana, baria, yttria, neodymia, praseodymia, titania, europia, samaria, hafnia, and any composite or combination thereof. An exemplary support may be a composite oxide of silica- alumina, alumina-zirconia, alumina-lanthana, alumina-chromia, alumina-baria or alumina-ceria.

It will be understood that two or more precious metal components, if present, may possibly be supported on same or different support particles; and the same precious metal component may possibly be supported on one or more types of support particles.

### Second Catalyst

The second catalyst comprises a molecular sieve component which may be a zeolitic or non-zeolitic molecular sieve having a selective catalytic reduction (SCR) activity. The molecular sieve component useful for the second catalyst is optionally metal-promoted. Herein, a molecular sieve refers to a framework material based on an extensive three-dimensional network of oxygen ions containing generally tetrahedral type sites and having a substantially uniform pore distribution. Suitable molecular sieves for the purpose of the present invention may be microporous or mesoporous.

Particularly, the molecular sieve component may be zeolites which are optionally metal-promoted. Herein, the term “metal-promoted” within the context of the molecular sieve is intended to mean a metal capable of improving any performance of the zeolite has been incorporated into and/or onto the zeolite.

Preferably, suitable molecular sieves may include, but are not limited to aluminosilicate zeolites having a framework type selected from the group consisting of AEI, AEL, AFI, AFT, AFO, AFX,

AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC and WEN. More preferably, the molecular sieves include zeolites having a framework type selected from the group AEI, BEA (e.g., beta), CHA (e.g., chabazite, SSZ-13), AFT, AFX, FAU (e.g., zeolite Y), MOR, MFI (e.g., ZSM-5), MOR (e.g., mordenite) and MEL, among which CHA and AEI and are particularly preferred.

It will be appreciated that when a zeolite is mentioned by reference to the framework type code as generally accepted by the International Zeolite Association (IZA) herein, it is intended to include not only the reference material but also any isotypic framework materials having SCR catalytic activities. The list of reference material and the isotypic framework materials for each framework type code are available from the database of IZA (http://www.iza-structure.org/databases/).

In some embodiments, the molecular sieve component in the second catalyst may be a metal-promoted zeolite, which zeolite is selected from those as described hereinabove. The promoter metal may be selected from precious metals such as Au and Ag, platinum group metals such as Ru, Rh, Pd, In and Pt, base metals such as Cr, Zr, Nb, Mo, Fe, Mn, W, V, Al, Ti, Co, Ni, Cu, Zn, Sb, Sn and Bi, alkali earth metals such as Ca and Mg, and any combinations thereof. The promoter metal is preferably Fe or Cu or a combination thereof.

In some illustrative embodiments, the second catalyst comprises, as the molecular sieve component, a Cu and/or Fe promoted zeolite having the framework type of AEI, BEA, CHA, AFT, AFX, FAU, FER, KFI, MOR, MFI, MOR or MEL, particularly a Cu and/or Fe promoted zeolite having the framework of CHA and AEI.

The promoter metal may be present in the metal-promoted molecular sieve in an amount of 0.1 to 20% by weight, 0.5 to 15% by weight, 1 to 10% by weight or 2 to 6% by weight on an oxide basis, based on the total weight of metal-promoted molecular sieve. In some illustrative embodiments wherein Cu or Fe is used as the promoter metal, the promoter metal is preferably present in an amount of 0.5 to 15% by weight, or 1 to 15% by weight, or 1 to 10% by weight, on an oxide basis, based on the total weight of the metal-promoted molecular sieve.

The molecular sieve component may have an average crystallite size in the range of from 0.1 to 4.0 microns (μm), or from 0.5 to 1.5 μm.

When a molecular sieve having an aluminosilicate framework is used, e.g., aluminosilicate zeolite and metal-promoted aluminosilicate zeolite, the aluminosilicate framework preferably has a silica to alumina molar ratio (SAR) in the range of from 2 to 200, from 5 to 100, from 8 to 50, or from 10 to 30.

The second catalyst may optionally comprise a further component having an SCR activity, such as a vanadium-based SCR catalyst containing vanadium species on a refractory metal oxide support such as alumina, silica, zirconia, titania, ceria and combinations thereof. Vanadium-based SCR catalysts are well-known and widely used commercially in mobile exhaust treatment applications. For example, typical vanadium-based SCR catalyst compositions are described in U.S. Pat. Nos. 4,010,238 and 4,085,193, of which the entire contents are incorporated herein by reference. Exemplary vanadium-based SCR catalyst compositions used commercially, especially in mobile applications, comprise 5 to 20% by weight of WO₃ and 0.5 to 6% by weight of V₂O₅ supported on TiO₂ particles. Those vanadium-based SCR catalysts may comprise further inorganic materials such as SiO₂ and ZrO₂.

### Coating Configurations

In the catalytic article according to the present invention, the coating layer in the first coating configuration or the second coating layer in the second coating configuration respectively has inter-particle pores at a pore ratio of 5.7% or more, or 7.0% or more, preferably 8.0% or more, particularly 9.0% or more. More preferably, the coating layer in the first coating configuration or the second coating layer in the second coating configuration has inter-particle pores at a pore ratio of 25% or less, preferably 20% or less, particularly 15% or less.

Particularly, the coating layer in the first coating configuration or the second coating layer in the second coating configuration respectively has inter-particle pores at a pore ratio in the range of from 5.7% to 25%, or from 7.0% to 20%, or from 8.0% to 15%, or from 9.0% or 15%.

Herein, the inter-particle pores particularly refer to pores having a pore size of less than 50 microns (μm), preferably in the range of from 5 to 30 microns (μm), more preferably in the range of from 8 to 20 μm, as measured by scanning electron microscopy (SEM). The pore size of a pore refers to a diameter as determined by SEM assuming that the pore shape is a perfect circle.

In some embodiments, the catalytic article according to the present invention has the first coating configuration and comprises a coating layer comprising a first catalyst containing a precious metal component and a second catalyst containing a molecular sieve component (hereinbelow also referred to as “coating layer comprising a first catalyst and a second catalyst”). In other words, the first catalyst and the second catalyst are not separated in distinct layers, but physically blended in a single coating layer.

In those embodiments wherein the catalytic article according to the present invention has the first coating configuration, the coating layer comprising a first catalyst and a second catalyst may be arranged along the gas flow passages over the full axial length of the substrate, i.e., extending from the inlet end to the outlet end. Alternatively, the coating layer comprising a first catalyst and a second catalyst may extend from the outlet end toward the inlet end along the gas flow passages over partial axial length of the substrate, for example 30 to less than 100%, including 40%, 50%, 60%, 70%, 80% or 90% of length of the substrate. In the latter case, another coating layer, for example another SCR catalyst coating layer may be arranged upstream, i.e., from the inlet end toward the outlet end over partial length of the substrate.

The first catalyst and the second catalyst may be comprised in the coating layer comprising a first catalyst and a second catalyst at a weight ratio in the range of from 1:15 to 2:1, preferably from 1:10 to 1:1, more preferably from 1:8 to 1:2.

In some other embodiments, the catalytic article according to the present invention has the second coating configuration and comprises i) a first coating layer which comprises a first catalyst containing a precious metal component (hereinbelow, also referred to as “first coating layer”) and ii) a second coating layer which covers at least part of the first coating layer and comprises a second catalyst containing a molecular sieve component (hereinbelow, also referred to as “second coating layer”).

In those embodiments wherein the catalytic article has the second coating configuration, the second coating layer is directly on top of the first coating layer and may cover a part or whole of the first coating layer.

For example, in some particular embodiments, the catalytic article has the second coating configuration and comprises i) a first coating layer which comprises a first catalyst containing a precious metal component and ii) a second coating layer which comprises a second catalyst containing a molecular sieve component, wherein the first and second coating layers both extend along the gas flow passages over full axial length of the substrate and the second coating layer is directly on top of the first coating layer.

In some other particular embodiments, the catalytic article has the second coating configuration and comprises i) a first coating layer which comprises a first catalyst containing a precious metal component and ii) a second coating layer which comprises a second catalyst containing a molecular sieve component, wherein the first coating layer extends along the gas flow passages over full axial length of the substrate, the second coating layer is directly on top of the first coating layer and extends from the inlet end or outlet end along the gas flow passages over partial axial length of the substrate, for example 30 to less than 100%, including 40%, 50%, 60%, 70%, 80% or 90% of length of the substrate.

In some further particular embodiments, the catalytic article has the second coating configuration and comprises i) a first coating layer which comprises a first catalyst containing a precious metal component and ii) a second coating layer which comprises a second catalyst containing a molecular sieve component, wherein the first coating layer extends from the inlet end or outlet end along the gas flow passages over partial axial length of the substrate, for example 30 to less than 100%, including 40%, 50%, 60%, 70%, 80% or 90% of length of the substrate, and the second coating layer is directly on top of the first coating layer and extends along the gas flow passages over full axial length of the substrate.

In yet some particular embodiments, the catalytic article has the second coating configuration and comprises i) a first coating layer which comprises a first catalyst containing a precious metal component and ii) a second coating layer which comprises a second catalyst containing a molecular sieve component, wherein the first coating layer and the second coating layer extend from outlet end and inlet end respectively along the gas flow passages over partial axial length of the substrate respectively, for example 30 to less than 100%, including 40%, 50%, 60%, 70%, 80% or 90% of length of the substrate, and the second coating layer is directly on top of and overlaps the first coating layer.

Optionally, the catalytic article having the second coating configuration may further comprise a third coating layer adjacent to or overlapping the second coating layer. The third coating layer is for example another SCR catalyst coating layer which differs from the second coating layer, and may or may not have the pore ratio as described herein.

Accordingly, in certain particular embodiments, the catalytic article has the second coating configuration and comprises i) a first coating layer which comprises a first catalyst containing a precious metal component, ii) a second coating layer which comprises a second catalyst containing a molecular sieve component, and iii) a third SCR catalyst coating layer, wherein the first coating layer extends along the gas flow passages over full axial length of the substrate, the second and third coating layers are on top of the first coating layer and extend from opposite ends along the gas flow passages over partial axial length of the substrate. For example, the second coating layer extends from the inlet end and the third coating layer extends from the outlet end, both being along the gas flow passages over partial axial length of the substrate.

In the above embodiments wherein the catalytic article has the second coating configuration, the first catalyst and the second catalyst may be comprised at a weight ratio in the range of from 1:15 to 2:1, preferably from 1:10 to 1:1, more preferably from 1:8 to 1:2.

It will be understood that a single piece or more than one piece of substrate may be present in the catalytic articles having the second coating configuration as described herein without any restrictions. For example, the catalytic article as described in the “some other particular embodiments” hereinabove may comprise two pieces of substrates, with one piece carrying a part of the first coating layer and the second coating layer, and the other piece carrying the remaining part of the first coating layer.

Any possible variations including two or more pieces of substrates can be contemplated and included in the present invention.

In any embodiments according to the present invention, the precious metal component may be present in a total amount of 0.01 to 20 g/ft^{3,} preferably 0.5 to 10 g/ft^{3,} more preferably 1.5 to 5 g/ft³ calculated as respective precious metal, based on the volume of the substrate.

Additionally or alternatively, the molecular sieve component may be present in a total amount of 0.5 to to 6.0 g/in^{3,} preferably 1.0 to 4.0 g/in^{3,} more preferably 1.5 to 3.0 g/in^{3,} based on the volume of the substrate.

Any of the coating layers as described herein may also comprise one or more other components in addition to the catalysts. The other components may be non-catalytically active components, for example processing aids useful in the preparation of catalytic articles, such as stabilizer, surfactant and binders.

The other components may also be catalytically active. For example, when the catalytic article according to the present invention comprises the first coating layer and the second coating layer as described herein, the first coating layer may further comprise a zeolitic or non-zeolitic molecular sieve component. Suitable molecular sieves may be selected from those molecular sieve components as described for the second catalyst.

The catalytic article according to the present invention may be prepared by a conventional washcoating process. The washcoating process generally comprises applying one or more slurries comprising respective catalysts onto a substrate. For the purpose of the present invention, a pore-forming agent in form of particles is used in the one or more slurries for providing the inter-particle pores at the desired pore ratio in the obtained coating layer(s). The pore-forming agent is comprised in a slurry from which the coating layer in the first coating configuration or the second coating layer in the second coating configuration having the desired pore ratio will be obtained upon calcination.

Accordingly, in the second aspect, the present invention provides a process for preparing a catalytic article for treating an exhaust stream, which comprises
applying a slurry comprising a first catalyst containing a precious metal component, a second catalyst containing a molecular sieve component and a pore-forming agent onto a substrate, optionally drying, and calcining to form a coating layer in a first coating configuration, or
applying a first slurry comprising a first catalyst containing a precious metal component onto a substrate and drying and/or calcining to form a first coating layer, and then applying a second slurry comprising a second catalyst containing a molecular sieve component and a pore-forming agent, optionally drying, and calcining to form a second coating layer in a first coating configuration,
wherein the pore-forming agent is in form of particles and used in an amount of at least 15% by weight, based on the loading of the coating layer in the first coating configuration or the second coating layer in the second coating configuration respectively.

It can be contemplated that the substrate for carrying the coating layer in the first coating configuration or the first coating layer in the second coating configuration may be a blank substrate or may have been coated with any suitable bottom coating layer. The blank substrate is intended to mean a substrate carrying no coating layer before the coating layer in the first coating configuration or the first coating layer in the second coating configuration is applied onto it.

The pore-forming agent is preferably used in an amount of at least 18% by weight, or at least 20% by weight, based on the loading of the coating layer in the first coating configuration or the second coating layer in the second coating configuration respectively. Particularly, the pore-forming agent may be used in an amount of 50% by weight or less, or 40% by weight or less, based on the loading of the coating layer in the first coating configuration or the second coating layer in the second coating configuration respectively.

Particularly, the pore-forming agent may be used in an amount of from 18% to 50% by weight, or from 20% to 40% by weight, based on the loading of the coating layer in the first coating configuration or the second coating layer in the second coating configuration respectively.

The pore-forming agent may be organic or inorganic material particles which can be burned-off and leave voids during the calcination step to provide a coating layer. For example, the pore-forming agent may be selected from organic materials such as natural and synthetic polymers, organic small molecule compounds, inorganic materials such as inorganic salts and carbon materials, cellulose-containing natural materials, and any combinations thereof.

Suitable natural and synthetic polymers as the pore-forming agent may include, but are not limited to, polyether polyols such as polyethylene glycols and alkyl-capped derivatives thereof, styrenic homopolymers or copolymers such as polystyrenes, poly (meth) acrylic acids and ester derivatives thereof such as polymethyl methacrylate, celluloses, ether and ester derivatives of celluloses, polyvinyl alcohols, polyvinyl pyrrolidones and any combinations thereof.

Suitable organic small molecule compounds as the pore-forming agent may include, but are not limited to, benzoic acid and derivatives thereof, carbamide (urea), sugar crystals and any combinations thereof.

Suitable inorganic salts as the pore-forming agent may include, but are not limited to, ammonium bicarbonate, magnesium carbonate, and any combinations thereof.

Suitable carbon materials as the pore-forming agent may include, but are not limited to, carbon black, carbon fiber, graphite and any combinations thereof.

Suitable cellulose-containing natural materials as the pore-forming agent may be granulated products from dried plants which include, but are not limited to sunflower, cotton, rice, wheat, sorghum, breadfruit tree, sugar cane, corn, bamboo and any combinations thereof. The granulated products may be obtained from various parts of plants such as leaf, bark, straw, root, husk and any combinations thereof.

The pore-forming agent may be particles having a variety of geometries, including but are not limited to spheres, tablets, cylinders or fibers. Preferably, the pore-forming agent has an average particle size D₅₀ in the range of from 15 to 25 μm, preferably from 17 to 21 μm.

The steps of preparing and applying of a slurry, drying and calcination of a coated slurry may all be carried out in conventional ways for a washcoating process, without any particular restrictions. Generally, a slurry for washcoating may be prepared by suspending finely divided particles of a catalyst in an appropriate vehicle, e.g., water, to which a promoter, a stabilizer and/or a surfactant may be added in forms of solutions in water or a water-miscible vehicle. The slurry may be comminuted/milled to result in substantially all of the solids having average particle sizes of less than 10 microns, e.g., in the range of from 0.1 to 8 microns. The comminution/milling may be accomplished in a ball mill, continuous Eiger mill, or other similar equipments. The suspension or slurry generally has a pH of 2 to less than 9, and may be adjusted if necessary by adding an inorganic or organic acid or base. The solids content of the slurry may be, e.g., 15 to 60% by weight. The obtained slurry may be applied on a substrate by dipping the substrate into the slurry, or otherwise coating onto the substrate, such that a desired loading of a catalyst coating layer will be deposited on the substrate. Thereafter, the coated substrate may optionally be dried at a temperature in the range of from 100 to 300° C. The calcining is generally carried out by heating at a temperature in the range of from 350 to 650° C. for a period of time, for example 1 to 3 hours. Drying and calcination are typically done in air. The coating, drying, and calcination processes may be repeated if necessary to achieve the final desired gravimetric amount of the coating layer on the support. The loading of a coating layer may be determined through calculation of the difference in the weights before and after applying the coating layer. The pore-forming agent, when used, may be incorporated into the slurry at any timing during the preparation of the slurry, for example after the comminution/milling.

The catalytic article according to the present invention may be used to treat exhaust streams from combustion engines of automobiles, especially diesel engines.

Accordingly, in the third aspect, the present invention relates to a system for treating an exhaust stream, especially originating from diesel engines, which comprises a reductant source (e.g., NH₃ or a precursor thereof) and the catalytic article as described in the first aspect hereinabove or as obtained from the process as described in the second aspect hereinabove.

The system for treating an exhaust stream may further comprise one or more exhaust stream treatment elements. Conventional exhaust stream treatment elements include, but are not limited to diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

In some embodiments, the system for treating an exhaust stream further comprises a diesel oxidation catalyst (DOC) and a selective catalytic reduction (SCR) catalyst located downstream of the engine and upstream of the catalytic article. Preferably, the system for treating an exhaust stream further comprises a diesel oxidation catalyst (DOC), a catalyzed soot filter (CSF) and a selective catalytic reduction (SCR) catalyst located upstream of the catalytic article.

In the fourth aspect, the present invention relates to a method for treatment of an exhaust stream containing nitrogen oxides, which comprises contacting the exhaust stream with the catalytic article as described in the first aspect or passing the exhaust stream through the system as described in the third aspect, in the presence of NH₃ as a reductant. The method is particularly useful for treatment of an exhaust stream originating from diesel engines.

### EMBODIMENTS

Various embodiments are listed below. It will be understood that the embodiments listed below may be combined with all aspects and other embodiments in accordance with the scope of the invention.

1. A catalytic article for treating an exhaust stream, which comprises
a substrate,
a coating layer, comprising a first catalyst containing a precious metal component and a second catalyst containing a molecular sieve component,
in a first coating configuration; or
a substrate,
a first coating layer, which comprises a first catalyst containing a precious metal component, and
a second coating layer, which covers at least part of the first coating layer and comprises a second catalyst containing a molecular sieve component,
in a second coating configuration;
wherein the coating layer in the first coating configuration or the second coating layer in the second coating configuration has inter-particle pores at a pore ratio of 5.7% or more respectively.

2. The catalytic article according to Embodiment 1, wherein the molecular sieve is selected from zeolites which are optionally metal-promoted.

3. The catalytic article according to Embodiment 1 or 2, wherein the molecular sieve component is selected from aluminosilicate zeolites having a framework type selected from the group consisting of AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC and WEN, preferably AEI, BEA, CHA, AFT, AFX, FAU, MOR, MFI, MOR and MEL, more preferably CHA and AEI.

4. The catalytic article according to any of preceding Embodiments, wherein the molecular sieve component has an average crystallite size in the range of from 0.1 to 4 microns.

5. The catalytic article according to Embodiment 4, wherein the molecular sieve component has an average crystallite size in the range of from 0.5 to 1.5 microns.

6. The catalytic article according to any of preceding Embodiments, wherein the coating layer in the first coating configuration or the second coating layer in the second coating configuration respectively has inter-particle pores at a pore ratio of 7.0% or more.

7. The catalytic article according to Embodiment 6, wherein the coating layer in the first coating configuration or the second coating layer in the second coating configuration respectively has inter-particle pores at a pore ratio of 8.0% or more.

8. The catalytic article according to Embodiment 7, wherein the coating layer in the first coating configuration or the second coating layer in the second coating configuration respectively has inter-particle pores at a pore ratio of 9.0% or more.

9. The catalytic article according to any of preceding Embodiments, wherein the coating layer in the first coating configuration or the second coating layer in the second coating configuration has inter-particle pores at a pore ratio of 25% or less.

10. The catalytic article according to Embodiment 9, wherein the coating layer in the first coating configuration or the second coating layer in the second coating configuration has inter-particle pores at a pore ratio of 20% or less.

11. The catalytic article according to Embodiment 10, wherein the coating layer in the first coating configuration or the second coating layer in the second coating configuration has inter-particle pores at a pore ratio of 15% or less.

12. The catalytic article according to any of preceding Embodiments, wherein the substrate has an inlet end and an outlet end which define an axial length thereof and a plurality of fine, parallel gas flow passages extending along the axial length, for example a flow-through substrate or a wall-flow substrate, preferably a flow-through substrate.

13. The catalytic article according to any of preceding Embodiments, which has the second coating configuration wherein the second coating layer is directly on top of the first coating layer and covers a part or whole of the first coating layer.

14. The catalytic article according Embodiment 12, which has the second coating configuration wherein the first coating layer and the second coating layer both extend along the gas flow passages over full axial length of the substrate.

15. The catalytic article according to Embodiment 14, wherein the second coating layer is directly on top of the first coating layer.

16. A process for preparing a catalytic article for treating an exhaust stream, which comprises
applying a slurry comprising a first catalyst containing a precious metal component, a second catalyst containing a molecular sieve component and a pore-forming agent onto a substrate, optionally drying, and calcining to form a coating layer in a first coating configuration, or
applying a first slurry comprising a first catalyst containing a precious metal component onto a substrate and drying and/or calcining to form a first coating layer, and then applying a second slurry comprising a second catalyst containing a molecular sieve component and a pore-forming agent, optionally drying, and calcining to form a second coating layer in a first coating configuration,
wherein the pore-forming agent is in form of particles and used in an amount of at least 15% by weight, based on the loading of the coating layer in the first coating configuration or the second coating layer in the second coating configuration respectively.

17. The process according to Embodiment 16, wherein a catalytic article for treating an exhaust stream according to any of Embodiments 1 to 15 is prepared.

18. The process according to Embodiment 16 or 17, wherein the pore-forming agent is used in an amount of at least 18% by weight, based on the loading of the coating layer in the first coating configuration or the second coating layer in the second coating configuration respectively.

19. The process according to Embodiment 18, wherein the pore-forming agent is used in an amount of at least 20% by weight, based on the loading of the coating layer in the first coating configuration or the second coating layer in the second coating configuration respectively.

20. The process according to any of Embodiments 16 to 19, wherein the pore-forming agent is used in an amount of 50% by weight or less, based on the loading of the coating layer in the first coating configuration or the second coating layer in the second coating configuration respectively.

21. The process according to Embodiment 20, wherein the pore-forming agent is used in an amount of 40% by weight or less, based on the loading of the coating layer in the first coating configuration or the second coating layer in the second coating configuration respectively.

22. The process according to any of Embodiments 16 to 21, wherein the pore-forming agent is selected from organic materials such as natural and synthetic polymers, organic small molecule compounds, inorganic materials such as inorganic salts and carbon materials, cellulose-containing natural materials, and any combinations thereof.

23. The process according to Embodiment 22, wherein the pore-forming agent is selected from polyether polyols such as polyethylene glycols and alkyl-capped derivatives thereof, styrenic homopolymers or copolymers such as polystyrenes, poly (meth) acrylic acids and ester derivatives thereof such as polymethyl methacrylate, celluloses, ether and ester derivatives of celluloses, polyvinyl alcohols, polyvinyl pyrrolidones and any combinations thereof.

24. The process according to any of Embodiments 16 to 23, wherein the pore-forming agent has an average particle size D₅₀ in the range of from 15 to 25 μm.

25. The process according to Embodiment 24, wherein the pore-forming agent has an average particle size D₅₀ in the range of from 17 to 21 μm.

26. A system for treating an exhaust stream, which comprises a reductant source (e.g. NH₃ or a precursor thereof), the catalytic article according to any of preceding Embodiments 1 to 10 or the catalytic article obtained from the process according to any of Embodiments 11 to 17, and optionally one or more of diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

27. The system according to Embodiment 26, wherein the exhaust stream originates from an internal combustion engine, especially a diesel engine.

28. A method for treatment of an exhaust stream containing nitrogen oxides, which comprises contacting the exhaust stream with the catalytic article according to any of preceding Embodiments 1 to 15 or the catalytic article obtained from the process according to any of Embodiments 16 to 25, or passing the exhaust stream through the system as defined in Embodiment 26 or 27, in the presence of NH₃ as a reductant.

The invention will be further illustrated by following Examples, which set forth particularly advantageous embodiments. While the Examples are provided to illustrate the present invention, they are not intended to limit it.

### EXAMPLES

### Comparative Example 1

### Preparation of an AMOx Slurry

4.5 g of an aqueous solution of tetraammineplatinum (II) hydroxide (H₁₄N₄O₂ Pt, 12.6% Pt) was diluted into water and then loaded via incipient-wetness impregnation to 250 g of a Al₂O₃—SiO₂ composite oxide powder support (98.5 wt % Al₂O₃ and 1.5 wt % SiO₂) under constant agitation to ensure an even distribution, to provide a slurry with a solid content of 42 wt %. Afterwards, the slurry was adjusted to a pH of about 4.0 and then was milled to a particle size of D₉₀ of 7 μm, as measured with a Sympatec particle size analyzer.

### Preparation of an SCR Slurry Containing Cu-CHA

78.7 g aqueous zirconia acetate binder having a solid content of 30.0 wt % (calculated as ZrO₂) was added dropwise into 160 g DI water under stirring. After well-mixing, 510.7 g Cu-CHA powder having a solid content of 88.6 wt %, a Cu content of 5.0% (calculated as CuO based on solid content) and a SAR (SiO_{2/}Al₂O₃ ratio) of 17 was added slowly under stirring at 400 rpm for 12 hours, and the obtained slurry was milled to a particle size D₉₀ of 6 μm as measured with a Sympatec particle size analyzer. Then 79.3 g alumina sol having a solid content of 30 wt % was added under stirring at 400 rpm. The final solid content was adjusted with DI H₂O to 37 wt % before coating.

Applying Coating Layers onto Substrate

A ceramic flow-through monolithic core (1″×3″, 600 cpsi/3 mils) as the substrate was first applied with an AMOx coating layer by submerging it in the AMOx slurry. Excess slurry was blown off using compressed air carefully, followed by briefly drying in flowing air at 250° C., and then calcined in a muffle furnace at 550° C. (ramp 4° C./min) for 1 hour. After cooling to 250° C., the coated substrate was weighed to determine the AMOx catalyst loading. The loading of the AMOx coating layer is 0.5 g/in³ (30 g/L), and Pt loading is 2.0 g/ft^{3.} Thereafter, a SCR coating layer was applied using the same process as described above for the AMOx coating layer, with the loading of the SCR coating layer of 2.2 g/in³ (135 g/L), and the Cu-CHA loading is 2.0 g/in³.

### Comparative Example 2

The process as described in Comparative Example 1 was repeated except that the SCR slurry containing Cu-CHA further comprises 25.0 g polymethyl methacrylate (PMMA, SUNPMMA-S200 from SUNJIN Chemical) with D₅₀=19 μm as measured with a Sympatec particle size analyzer, which was added into the SCR slurry and stirred homogeneously after adding the alumina sol was completed.

### Comparative Example 3

The process as described in Comparative Example 2 was repeated except that the SCR slurry containing Cu-CHA comprises 50.0 g polymethyl methacrylate (PMMA).

### Comparative Example 4

The process as described in Comparative Example 2 was repeated except that the SCR slurry containing Cu-CHA comprises 65.0 g polymethyl methacrylate (PMMA).

### Example 1

The process as described in Comparative Example 2 was repeated except that the SCR slurry containing Cu-CHA comprises 100.0 g polymethyl methacrylate (PMMA).

### Example 2

The process as described in Comparative Example 2 was repeated except that the SCR slurry containing Cu-CHA comprises 150.0 g polymethyl methacrylate (PMMA).

### Example 3

The process as described in Comparative Example 2 was repeated except that the SCR slurry containing Cu-CHA comprises 200.0 g polymethyl methacrylate (PMMA).

### Example 4

The process as described in Comparative Example 2 was repeated except that the SCR slurry containing Cu-CHA comprises 250.0 g polymethyl methacrylate (PMMA).

### Comparative Example 5

The process as described in Comparative Example 1 was repeated except that 461.9 Cu-AEI powder having a solid content of 98.0 wt %, a Cu content of 5.0% (calculated as CuO based on solid content) and a SAR (SiO_{2/}Al₂O₃ ratio) of 16 was used in place of the Cu-CHA powder.

### Example 5

The process as described in Comparative Example 5 was repeated except that the SCR slurry containing Cu-AEI further comprises 100.0 g polymethyl methacrylate (PMMA) which was added into the SCR slurry and stirred homogeneously after adding the alumina sol was completed.

### Measurement of Pore Ratio

Each fresh sample as obtained from above Examples and Comparative Examples was measured for the pore ratio through Scanning Electron Microscopy/Energy Dispersive X-Ray Spectroscopy (SEM/DES, Supra 55 from Zeiss company). A picture was taken from a cross section of the substrate which is perpendicular to the axial direction of the substrate to determine the total section area of the SCR coating layer and the total section area of pores in the SCR coating layer. The pore ratio is calculated in accordance with

$$Pore ratio = ( Ap / Ac ) \times 100 \%$$

in which
Ap is the total section area of pores in the SCR coating layer, and
Ac is the total section area of the SCR coating layer.

The total section area of pores may be determined by measuring the area of each pore section as observed from the picture of the cross section automatically by SEM/DES and summing up. Also, the total section area of the SCR coating layer may be determined in the same way. An average of measurements on three pictures was reported as the pore ratio result.

### Performance Test

All the catalytic performance tests were carried out on a flow reactor using simulated diesel exhausts having a composition shown below as the feed gas for aged samples prepared from fresh samples from above Examples and Comparative Examples by aging in 10 vol % water/air at 650° C. for 50 hours. Prior to testing, the aged samples were pretreated under 550° C. in N₂ for 0.5 hour, and cooled down to 250° C.

Feed gas: 500 ppm NH₃ in 10% O₂, 8% CO₂, 7% H₂O and the balanced of N_{2,} at a space velocity of 100,000 h⁻¹.

The feed gas was purged into the reactor until a steady state of NH₃ slip was reached, and then the amount of NH₃ slip ([NH₃]ₒᵤₜ) was recorded for calculating NH₃ conversion in accordance with the following Equation:

$${Conversion}_{N H 3} = ( {[ {NH}_{3} ]}_{i n} - {[ {NH}_{3} ]}_{o u t} ) {/ [ {NH}_{3} ]}_{i n} \times 100 \% .$$

TABLE 1

| | | SCR coating layer | | | NH₃ |
|---|---|---|---|---|---|
| Example | AMOx | molecular | PMMA | Pore | conversion |
| No. | coating layer | sieve | usage | ratio | at 250° C. |
| Comparative | Pt/ | Cu-CHA | 0 | 0 | 77.6% |
| Example 1 | Al₂O₃—SiO₂ | | | | |
| Comparative | | | 5% | 2.3% | 74.8% |
| Example 2 | | | | | |
| Comparative | | | 10% | 4.7% | 81.5% |
| Example 3 | | | | | |
| Comparative | | | 13% | 5.5% | 76.2% |
| Example 4 | | | | | |
| Example 1 | | | 20% | 9.2% | 89.3% |
| Example 2 | | | 30% | 11.4% | 86.3% |
| Example 3 | | | 40% | 12.6% | 83.9% |
| Example 4 | | | 50% | 16.2% | 80.1% |
| Comparative | | Cu-AEI | 0 | 0 | 74.0% |
| Example 5 | | | | | |
| Example 5 | | | 20% | 6.8% | 84.7% |

As shown in the Table above, the catalytic articles according to the present invention show improved NH₃ conversions as compared with the conventional catalytic articles having no pores (Examples 1 to 4 vs. Comparative Example 1, Example 5 vs. Comparative Example 5).

It was also surprisingly found by the inventors that the performances of the catalytic articles are not mathematically proportional to the pore ratios. In other words, a catalytic article will not necessarily perform better as the pore ratio increases. It can be seen, the catalytic articles having pore ratios of 5% and 13% even show lower NH₃ conversions than the conventional catalytic article having a pore ratio of zero (Comparative Examples 2 and 4 vs. Comparative Example3), although the catalytic article having a pore ratio of 10% performed better than the conventional catalytic article having a pore ratio of zero.

1. A catalytic article for treating an exhaust stream, which comprises
a substrate,
a coating layer, comprising a first catalyst containing a precious metal component and a second catalyst containing a molecular sieve component,
in a first coating configuration; or
a substrate,
a first coating layer, which comprises a first catalyst containing a precious metal component, and
a second coating layer, which covers at least part of the first coating layer and comprises a second catalyst containing a molecular sieve component,
in a second coating configuration;
wherein the coating layer in the first coating configuration or the second coating layer in the second coating configuration has inter-particle pores at a pore ratio of 5.7% or more respectively.

2. The catalytic article according to claim 1, wherein the molecular sieve is selected from zeolites which are optionally metal-promoted.

3. The catalytic article according to claim 1, wherein the molecular sieve component is selected from aluminosilicate zeolites having a framework type selected from the group consisting of AEI, AEL, AFI, AFT, AFO, AFX, AFR, ATO, BEA, CHA, DDR, EAB, EMT, ERI, EUO, FAU, FER, GME, HEU, JSR, KFI, LEV, LTA, LTL, LTN, MAZ, MEL, MFI, MOR, MOZ, MSO, MTW, MWW, OFF, RTH, SAS, SAT, SAV, SBS, SBT, SFW, SSF, SZR, TON, TSC and WEN, preferably AEI, BEA, CHA, AFT, AFX, FAU, MOR, MFI, MOR and MEL, more preferably CHA and AEI.

4. The catalytic article according to claim 1, wherein the molecular sieve component has an average crystallite size in the range of from 0.1 to 4 microns or from 0.5 to 1.5 microns.

5. The catalytic article according to claim 1, wherein the coating layer in the first coating configuration or the second coating layer in the second coating configuration respectively has inter-particle pores at a pore ratio of 7.0% or more, preferably 8.0% or more, particularly 9.0% or more.

6. The catalytic article according to claim 1, wherein the coating layer in the first coating configuration or the second coating layer in the second coating configuration has inter-particle pores at a pore ratio of 25% or less, preferably 20% or less, particularly 15% or less.

7. The catalytic article according to claim 1, wherein the substrate has an inlet end and an outlet end which define an axial length thereof and a plurality of fine, parallel gas flow passages extending along the axial length, for example a flow-through substrate or a wall-flow substrate, preferably a flow-through substrate.

8. The catalytic article according to claim 1, which has the second coating configuration wherein the second coating layer is directly on top of the first coating layer and covers a part or whole of the first coating layer.

9. The catalytic article according claim 7, which has the second coating configuration wherein the first coating layer and the second coating layer both extend along the gas flow passages over full axial length of the substrate.

10. The catalytic article according to claim 9, wherein the second coating layer is directly on top of the first coating layer.

11. A process for preparing a catalytic article for treating an exhaust stream, which comprises
applying a slurry comprising a first catalyst containing a precious metal component, a second catalyst containing a molecular sieve component and a pore-forming agent onto a substrate, optionally drying, and calcining to form a coating layer in a first coating configuration, or
applying a first slurry comprising a first catalyst containing a precious metal component onto a substrate and drying and/or calcining to form a first coating layer, and then applying a second slurry comprising a second catalyst containing a molecular sieve component and a pore-forming agent, optionally drying, and calcining to form a second coating layer in a first coating configuration,
wherein the pore-forming agent is in form of particles and used in an amount of at least 15% by weight, based on the loading of the coating layer in the first coating configuration or the second coating layer in the second coating configuration respectively.

12. The process according to claim 11, wherein a catalytic article for treating an exhaust stream which comprises
a substrate,
a coating layer, comprising a first catalyst containing a precious metal component and a second catalyst containing a molecular sieve component, in a first coating configuration; or
a substrate,
first coating layer, which comprises a first catalyst containing a precious metal Component, and
a second coating layer, which covers at least part of the first coating layer and comprises a second catalyst containing a molecular sieve component,
in a second coating configuraiton;
wherein the coating layer in the first coating configuration or the second coating layer in the second coating configuration has inter-particle pores at a pore ratio of 5.7% or more respectively, is prepared.

13. The process according to claim 11, wherein the pore-forming agent is used in an amount of at least 18% by weight, or at least 20% by weight, based on the loading of the coating layer in the first coating configuration or the second coating layer in the second coating configuration respectively.

14. The process according to claim 1, wherein the pore-forming agent is used in an amount of 50% by weight or less, or 40% by weight or less based on the loading of the coating layer in the first coating configuration or the second coating layer in the second coating configuration respectively.

15. The process according to claim 11, wherein the pore-forming agent is selected from organic materials such as natural and synthetic polymers, organic small molecule compounds, inorganic materials such as inorganic salts and carbon materials, cellulose-containing natural materials, and any combinations thereof.

16. The process according to claim 15, wherein the pore-forming agent is selected from polyether polyols such as polyethylene glycols and alkyl-capped derivatives thereof, styrenic homopolymers or copolymers such as polystyrenes, poly (meth) acrylic acids and ester derivatives thereof such as polymethyl methacrylate, celluloses, ether and ester derivatives of celluloses, polyvinyl alcohols, polyvinyl pyrrolidones and any combinations thereof.

17. The process according to claim 11, wherein the pore-forming agent has an average particle size D50 in the range of from 15 to 25 μm, preferably from 17 to 21 μm.

18. A system for treating an exhaust stream, which comprises a reductant source (e.g. NH₃ or a precursor thereof), a catalytic article for treating an must stream, which comprises
a substrate,
a coating layer, comprising a first catalyst containing a precious metal component and a second catalyst containing a molecular sieve component,
in a first coating configuration; or
a substrate,
a first coating layer, which comprises a first catalyst containing precious metal component and
a second coating layer, which cover at least part of the first coating layer and comprises a second catalyst containing a molecular sieve component,
in a second coating configuraiton;
wherein the coating layer in the first coating configuration or the second coating layer in the second coating configuration has inter-particle pores at a pore ratio of 5.7% or more respectively,
or the catalytic article obtained from the process according to claim 11, and optionally one or more of diesel oxidation catalyst (DOC), selective catalytic reduction catalyst (SCR), three-way conversion catalyst (TWC), four-way conversion catalyst (FWC), non-catalyzed or catalyzed soot filter (CSF), NOx trap, hydrocarbon trap catalyst, sensor and mixer.

19. The system according to claim 18, wherein the exhaust stream originates from an internal combustion engine, especially a diesel engine.

20. A method for treatment of an exhaust stream containing nitrogen oxides, which comprises contacting the exhaust stream with atle catalytic article for treating an exhaust stream, which comprises
a substrate.
a coating layer, comprising a first catalyst containing a precious metal component and a second catalyst containing a molecular sieve component,
in a first coating configuration; or
a substrate,
a first coating layer, which comprises a first catalyst containing a precious metal component, and
a second coating layer, which covers at least part of the first coating laver and comprises a second catalyst containing a molecular sieve component,
in a second coating configuration;
wherein the coating laver in the first coating configuration or the second coating layer in the second coating configuration has inter-particle pores at a pore ratio of 5.7% or more respectively, or a catalytic article obtained from a process for preparing a catalytic article for treating an exhaust stream, which comprises
applying a slurry comprising a first catalyst containing a precious metal component, a second catalyst containing a molecular sieve component and a pore-forming agent onto a substrate, optionally drying, and calcining to form a coating layer in a first coating configuration, or
applying a first slurry comprising a first catalyst containing a precious metal component onto a substrate and drying and/or calcining to form a first coating layer, and then applying a second slurry comprising a second catalyst containing a molecular sieve component and a pore-forming agent, optionally drying, and calcining to form a second coating layer in a first coating configuration,
wherein the pore-forming agent is in form of particles and used in an amount of at least 15% by weight, based on the loading of the coating layer in the first coating configuration of the second coating layer in the second coating configuration respectively, or passing the exhaust stream through the system as defined in claim 18, in the presence of NH₃ as a reductant.
